(19) United States
(12) Patent Application Publication
(10) Pub. No.: US 2020/0244299 A1
(43) Pub. Date: Jul. 30, 2020

(54) Mobile Phone Screen Protective Film

(71) Applicant: Dongya Zhang, Beijing (CN)

(72) Inventor: Dongya Zhang, Beijing (CN)

(21) Appl. No.: 16/609,769

(22) PCT Filed: Dec. 11, 2017
(86) PCT No.: PCT/CN2017/115472

§ 371 Date: Oct. 31, 2019

(30) Foreign Application Priority Data
Oct. 20, 2017 (CN) 201721354125.X

(51) Int. Cl. H04B 1/3888; B32B 3/26; B32B 7/06; B32B 7/12

(52) U.S. Cl. CPC H04B 1/3888; B32B 3/266; B32B 2405/00; B32B 7/12; B32B 7/06

(57) ABSTRACT

A mobile phone screen protective film comprises, in order from top to bottom, a surface film layer (1), a film-attaching layer (2), and a bottom film layer (3), wherein the layers are sequentially attached to one another. In this way, the issue of existing mobile phone screen protective films in which misalignment tends to occur during the attaching process which impacts the effect of the film and causes damage to the film body is resolved. The film can thus be well-positioned and attached during the attaching process.

### TECHNICAL FIELD

The present disclosure relates to the field of screen protection technologies, and specifically to a mobile phone screen protective film.

### BACKGROUND

With the development of electronic products and application of touch screens to the electronic products, more and more users pay attention to the touch screens. The touch screen is easy to break so that the user has a great demand on touch screen protection. Now, continuous upgrades of screen protector materials and influence of the electronic products on the vision of the user facilitate application of the screen protector, and the screen protector is not only used for protecting the touch screen, but also used for protecting the vision of the user.

In the prior art, the structure of the screen protector is tailored to the shape of the screen surface of various electronic products, but such structure has multiple problems in a screen protector pasting procedure. In an actual screen protector pasting procedure, firstly a bottom film of the screen protector needs to be torn down, one side of an exposed sticking surface is aligned to the screen, and then the bottom film is pulled to be completely stuck on the screen. In such pasting procedure, a sticking position is determined by one side of the sticking surface, which is easy to generate deviation. Additionally, the sticking surface of the screen protector utilizes an electrostatic adsorption manner, so, as long as the sticking surface of the screen protector comes into contact with the screen, it is completely adsorbed on the screen; and if the sticking position needs to be regulated, the screen protector needs to be removed to be aligned repeatedly. In the repeatedly removing and locating procedure, a screen protector body is easy to be damaged. Furthermore, in the operating procedure, the screen protector, especially its sticking surface, exposed in the air is easy to adsorb dusts, and if it is stuck on the screen again, there are unremovable bubbles to influence the screen displaying effect.

Therefore, the existing screen protector structure is easy to generate deviation to influence the screen protector pasting effect and to easily damage the screen protector body in the actual pasting procedure. A problem to be solved by the present disclosure is how to solve the problem in the prior art.

### SUMMARY

An objective of the present disclosure is to provide a mobile phone screen protective film to solve a problem that the existing mobile phone screen protective film is easy to generate deviation to influence a screen protector pasting effect and to easily damage a screen protector body in a pasting procedure.

To achieve the above objective, a technical solution of the present disclosure provides a mobile phone screen protective film. The mobile phone screen protective film sequentially comprises from top to bottom: a screen protector surface film layer, a screen protector sticking layer and a screen protector bottom film layer. The screen protector surface film layer is stuck on the screen protector sticking layer, and the screen protector sticking layer is stuck on the screen protector bottom film layer.

The screen protector surface film layer comprises a surface film sticking area and a surface film locating area. The surface film sticking area is in a rounded rectangle shape and is provided with a receiver hole at the top end and a button hole at the lower end. The surface film locating area of a product is in the shape of a Chinese character “tu” (convex).

With the development of electronic products, a part of mobile phone screens are not provided with a button. As a preferable manner, the button hole is not arranged at the lower end of the surface film sticking area.

The screen protector surface film layer is used for ensuring no damage to the screen protector sticking layer before use. The surface film locating area is used for aligning the mobile phone screen protective film to a groove of a mobile phone screen protective film locater.

The screen protector sticking layer comprises a sticking area and a locating area, which are disconnected and are stuck under the screen protector surface film layer. The sticking area is in a rounded rectangle shape and is provided with a receiver hole at the top end and a button hole at the lower end. The locating area is in the shape of a Chinese character “tu” (convex).

The screen protector sticking layer is a protective layer finally stuck on the mobile phone screen, and is used for protecting the mobile phone screen after being located and stuck.

As a preferable manner, the button hole is not arranged at the lower end of the sticking area of the screen protector sticking layer.

The screen protector bottom film layer comprises a bottom film sticking area, a cutting line and a bottom film locating area. The screen protector bottom film layer is stuck under the screen protector sticking layer, and the bottom film sticking area and the bottom film locating area are disconnected.

The bottom film sticking area is in a rounded rectangle shape and is provided with a receiver hole at the top end and a button hole at the lower end. The cutting line is arranged at the bottom film sticking area to divide the bottom film sticking area into two portions, and the cutting line is close to the button hole at the lower end. The bottom film locating area is in the shape of a Chinese character “tu” (convex).

As a preferable manner, the button hole is not arranged at the lower end of the bottom film sticking area.

The cutting line is used for ensuring automatic removal of the bottom film sticking area under the screen protector sticking layer through the pushing of a scrapper.

The present disclosure has the following advantage of solving the problem that the existing mobile phone screen protective film is easy to generate deviation to influence the screen protector pasting effect and to easily damage the screen protector body in the pasting procedure so that the screen protector can be greatly located and stuck in the pasting procedure.

### BRIEF DESCRIPTION OF THE DRAWINGS

FIG. 1 is a schematic structural diagram of a screen protector surface film layer of the present disclosure.

FIG. 2 is a schematic structural diagram of a screen protector sticking layer of the present disclosure.

FIG. 3 is a schematic structural diagram of a screen protector bottom film layer of the present disclosure.

FIG. 4 is a schematic diagram of a layer structure of a screen protector sticking area of the present disclosure.

### DESCRIPTION OF THE EMBODIMENTS

The following embodiments are for illustrative purposes and do not limit the scope of the present disclosure.

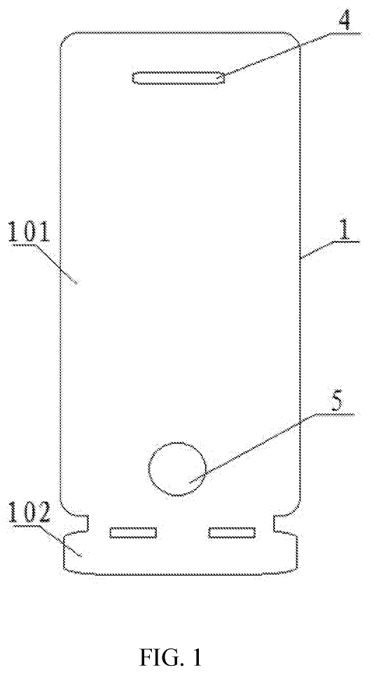

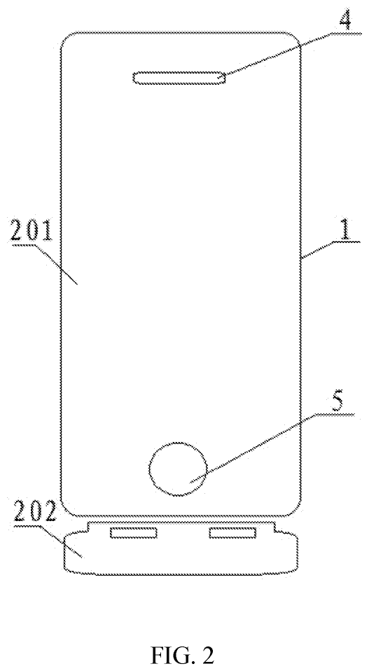

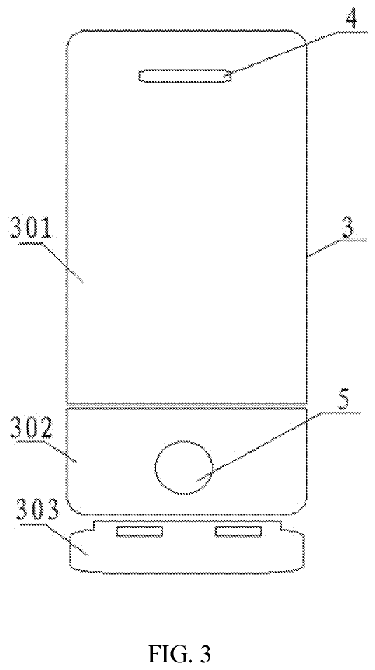

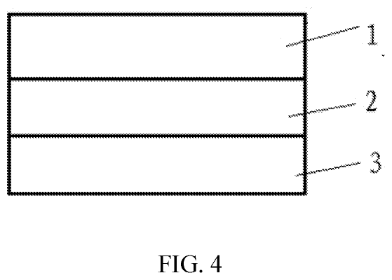

As shown in FIG. 1 to FIG. 4, the mobile phone screen protective film sequentially comprises from top to bottom: a screen protector surface film layer 1, a screen protector sticking layer 2 and a screen protector bottom film layer 3. The screen protector surface film layer 1 is stuck on the screen protector sticking layer 2, and the screen protector sticking layer 2 is stuck on the screen protector bottom film layer 3.

Wherein the screen protector surface film layer 1 comprises a surface film sticking area 101 and a surface film locating area 102. The surface film sticking area 101 is in a rounded rectangle shape and is provided with a receiver hole 4 at the top end and a button hole 5 at the lower end. The surface film locating area 102 is in the shape of a Chinese character “tu” (convex).

The screen protector sticking layer 2 comprises a sticking area 201 and a locating area 202, which are disconnected and are stuck under the screen protector surface film layer.

The screen protector bottom film layer 3 comprises a bottom film sticking area 301, a cutting line 302 and a bottom film locating area 303. The bottom film sticking area 301 is in a rounded rectangle shape and is provided with a receiver hole 4 at the top end and a button hole 5 at the lower end. The cutting line 302 is arranged above the button hole 5 of the bottom film sticking area 301. The bottom film locating area 303 is in the shape of a Chinese character “tu” (convex).

### Embodiment

When the mobile phone screen protective film is pasted, the back end of the mobile phone screen protective film is locked in a groove of a mobile phone screen protective film locater such that the mobile phone screen protective film is accurately aligned to a mobile phone screen. After the mobile phone screen protective film is accurately aligned, a scrapper is pressed on the cutting line 302 and the mobile phone screen protective film is turned over along the cutting line. The scrapper is pushed from the cutting line in a direction from the button hole 5 to the receiver hole 4 such that the bottom film sticking area 301 of the mobile phone screen protective film is separated from the screen protector sticking layer 2. The screen protector surface film layer 1 is torn down from the screen protector sticking layer 2. Finally, the scrapper is pressed on the cutting line 302 again and is pushed from the cutting line 302 in a direction from the receiver hole 4 to the button hole 5 such that the other portion of the bottom film sticking area 301 of the mobile phone screen protective film is separated from the screen protector sticking layer 2. After the bottom film sticking area 301 is removed, the screen protector sticking layer 2 is stuck on the mobile phone screen so as to achieve the pasting of the mobile phone screen protective film.

Although the present disclosure is described in detail above with reference to general description and specific embodiments, it is apparent to those skilled in the art that some changes or improvements can be made based on the present disclosure. Therefore, these changes or improvements made without departing from the spirit of the present disclosure shall be all contained in the protection scope of the present disclosure.

What is claimed is:

1. A mobile phone screen protective film, wherein the mobile phone screen protective film sequentially comprises from top to bottom: a screen protector surface film layer, a screen protector sticking layer and a screen protector bottom film layer; the screen protector surface film layer, the screen protector sticking layer and the screen protector bottom film layer are sequentially stuck and connected from top to bottom; and a cutting line is arranged in the screen protector bottom film layer.

2. The mobile phone screen protective film according to claim 1, wherein the screen protector surface film layer comprises a surface film sticking area and a surface film locating area; and the surface film sticking area and the surface film locating area are jointed together.

3. The mobile phone screen protective film according to claim 2, wherein the surface film sticking area is in a rounded rectangle shape and is provided with a receiver hole at the top end and a button hole at the lower end; and the surface film locating area is in the shape of a Chinese character “tu” (convex).

4. The mobile phone screen protective film according to claim 2, wherein the surface film sticking area is in a rounded rectangle shape and is provided with a receiver hole at the top end; and the surface film locating area is in the shape of a Chinese character “tu” (convex).

5. The mobile phone screen protective film according to claim 1, wherein the screen protector sticking layer comprises a sticking area and a locating area, which are disconnected and are stuck under the screen protector surface film layer.

6. The mobile phone screen protective film according to claim 5, wherein the sticking area is in a rounded rectangle shape and is provided with a receiver hole at the top end and a button hole at the lower end; and the locating area is in the shape of a Chinese character “tu” (convex).

7. The mobile phone screen protective film according to claim 5, wherein the sticking area is in a rounded rectangle shape and is provided with a receiver hole at the top end; and the locating area is in the shape of a Chinese character “tu” (convex).

8. The mobile phone screen protective film according to claim 1, wherein the screen protector bottom film layer comprises a bottom film sticking area, a cutting line and a bottom film locating area; the bottom film sticking area and the bottom film locating area are disconnected; and the cutting line is arranged at the bottom film sticking area.

9. The mobile phone screen protective film according to claim 8, wherein the bottom film sticking area is in a rounded rectangle shape and is provided with a receiver hole at the top end and a button hole at the lower end; the cutting line is arranged at the bottom film sticking area to divide the bottom film sticking area into two portions, and the cutting line is close to the button hole; and the surface film locating area is in the shape of a Chinese character “tu” (convex).

10. The mobile phone screen protective film according to claim 8, wherein the bottom film sticking area is in a rounded rectangle shape and is provided with a receiver hole at the top end; the cutting line is arranged at the bottom film sticking area to divide the bottom film sticking area into two portions; and the surface film locating area is in the shape of a Chinese character “tu” (convex).
